(19) United States
(12) Patent Application Publication
(10) Pub. No.: US 2019/0071247 A1
(43) Pub. Date: Mar. 7, 2019

(54) ERGONOMIC WASTE CONTAINER, CART AND RELATED METHODS

(71) Applicant: DCI Marketing, Inc. dba DCI-Artform, Milwaukee, WI (US)

(72) Inventors: Sandi J. Dzirbik, West Bend, WI (US); Mark N. Showers, Whitefish Bay, WI (US); Mark D. Bauer, Mount Prospect, IL (US)

(21) Appl. No.: 16/124,969

(22) Filed: Sep. 7, 2018

Related U.S. Application Data
(60) Provisional application No. 62/598,661, filed on Dec. 14, 2017.
(60) Provisional application No. 62/555,418, filed on Sep. 7, 2017.

(51) Int. Cl. B65F 1/06; B65F 1/16

(52) U.S. Cl. CPC B65F 1/06; B65F 2250/1143; B65F 1/16

(57) ABSTRACT

A receptacle comprising a one-piece molded body having opposing end walls and opposing side walls interconnecting the end walls and a bottom collectively defining an inner cavity with an upward facing opening, the body having an upper portion and a lower portion, wherein the opposing end walls have integral upper handles extending therefrom which are contoured and extend from the upper portion of the body, and wherein the lower portion of the body defines integral lower handles defined in each side of the body so that the receptacle may be lifted from any side thereof. Some forms of the receptacle further having a cover and/or a cart, and methods relating to all the aforesaid items.

### CROSS-REFERENCE TO RELATED APPLICATIONS

This application claims the benefit of U.S. Provisional Application No. 62/598,661, filed Dec. 14, 2017, and U.S. Provisional Application No. 62/555,418, filed Sep. 7, 2017, both of which are incorporated herein by reference in their entirety.

### FIELD

This invention relates generally to waste receptacles or containers and carts therefor, and, more particularly, to ergonomic waste receptacles for the temporary storage of organic waste to be transferred to a composting dumpster and methods relating to same.

### BACKGROUND

Waste containers or receptacles can be used in commercial kitchens, restaurants, grocery stores, or any location handling organic waste, to temporarily store organic waste. Organic waste is frequently kept separate from other waste in order to be composted or recycled in other manners. More and more jurisdictions are starting to require that organic waste be handled in this way and this trend is expected to continue, if not grow, going forward.

Many problems are associated with the storage of organic waste, namely concerns with hygiene, difficulty in transporting this waste from locations within retail establishments to the composting containers or dumpsters located outside of the retail establishment, difficulty in lifting such receptacles up to dump same into dumpsters, and problems getting workers to associate the receptacle with the correct form of waste to be deposited in same. With respect hygiene, organic waste quickly decomposes which releases foul odors. The decomposing waste is also a breeding ground for harmful bacteria and insects and attract other pests. Another hygienic problem with conventional organic waste containers is that they are often too big to conveniently clean using equipment commonly found in most retailers (e.g., storage areas with mop basins or sinks and hoses, utility sinks or tubs, commercial dish washers, etc.).

Additional problems include the size and weight of the waste receptacles. Large waste receptacles can block walkways in a crowded kitchen. Additionally, due to the density of organic waste, receptacles can often be difficult to transport out to dumpsters and/or lift up high enough to empty into a dumpster. The difficulty in emptying is compounded by the common smooth designs which are hard to grip. The weight of the organic matter can also cause the receptacle walls to bow-out and allow containers to be filled with too much waste or more waste than the receptacle is intended to hold, which makes the receptacle harder to transport out to a dumpster, harder to lift and can even cause the receptacle to crack or break when trying to lift same up to dump height, to dump the contents into a dumpster. In some retail establishments or retailers (e.g., grocery stores, restaurants, etc.), it may also be necessary to transport the waste through customer areas (e.g., the sales floor of a store such as a grocery store, a restaurant dining room, etc.). Thus, unsightly, bulging and odorous containers are not acceptable solutions for these types of applications.

Another problem associated with conventional organic waste receptacles is that they commonly are repurposed receptacles and, thus, it is hard for workers to distinguish what type of waste is to be discarded into which container (e.g., is it a regular trash receptacle; a paper, plastics, glass or metal recycling receptacle; is it an organic waste receptacle; etc.).

Accordingly, it has been determined that a need exists for an ergonomic organic waste receptacle that is properly sized to fit within a standard kitchen, that is easy to grip for emptying, and which has a smooth interior for easy cleaning.

### BRIEF DESCRIPTION OF THE FIGURES

Embodiments of the invention are illustrated in the figures of the accompanying drawings in which:

FIGS. 1A-1D illustrate an ergonomic waste receptacle according to some embodiments of the present invention. FIG. 1A is a perspective view of the ergonomic waste receptacle. FIG. 1B is a perspective view of the base of the ergonomic waste receptacle taken from below the product. FIG. 1C is a side elevation view of the ergonomic waste receptacle. FIG. 1D is a perspective view of the ergonomic waste receptacle taken from above to view into the receptacle.

FIG. 2 illustrates a perspective view of an ergonomic waste receptacle according to some embodiments of the present invention illustrating an optional cover that may be used with same.

FIG. 3 illustrates a perspective view of a double-wide ergonomic waste receptacle according to some embodiments of the present invention.

FIGS. 4A-4B are perspective views of a stack of the ergonomic waste receptacles of FIGS. 1A-1D and FIG. 2 illustrating the receptacles stacked with and without covers or lids, respectively.

FIGS. 5A-5C illustrate perspective views of a cart configured to transport the ergonomic waste receptacles of FIGS. 1-4.

FIG. 6 is a perspective view of a receptacle system comprising a plurality of waste receptacles on a cart.

FIG. 7A is a perspective view of another receptacle and lid in accordance with aspects of the invention illustrating a second receptacle stacked atop same.

FIG. 7B is a perspective view of the receptacle and lid of FIG. 7A taken from above.

FIG. 7C is a perspective view of the receptacle and lid of FIG. 7A taken from below.

FIGS. 8A-B are perspective views of another cart in accordance with aspects of the invention with FIG. 8A illustrating the cart with the receptacles of FIGS. 7A-C installed thereon and FIG. 8B illustrating the cart alone or empty.

FIGS. 8C-F are top, perspective, rear and right side elevation views, respectively, of the cart and receptacles of FIG. 8A.

FIGS. 9A-B are perspective views of an alternate receptacle or container in accordance with other aspects of the invention with FIG. 9A illustrating the receptacle from above and FIG. 9B illustrating the receptacle from below.

FIGS. 9C-F are front elevation, first cross-section, right side elevation and second cross-section views of the receptacle or container of FIGS. 9A-B, respectively, with FIG. 9D being taken along line A-A in FIG. 9C and FIG. 9F taken along line B-B of FIG. 9E.

FIG. 9G is a upside down perspective view of the receptacle or container of FIGS. 9A-F illustrating the receptacle or container with longer end handles prior to the handles being trimmed along the broken line to get the handles shown in FIGS. 9A-F and 9H.

FIG. 9H is a perspective view of the receptacle or container of FIGS. 9A-G illustrating the receptacle or container after the upper left and right side handles have been trimmed.

Elements in the figures are illustrated for simplicity and clarity and have not necessarily been drawn to scale or to include all features, options or attachments. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

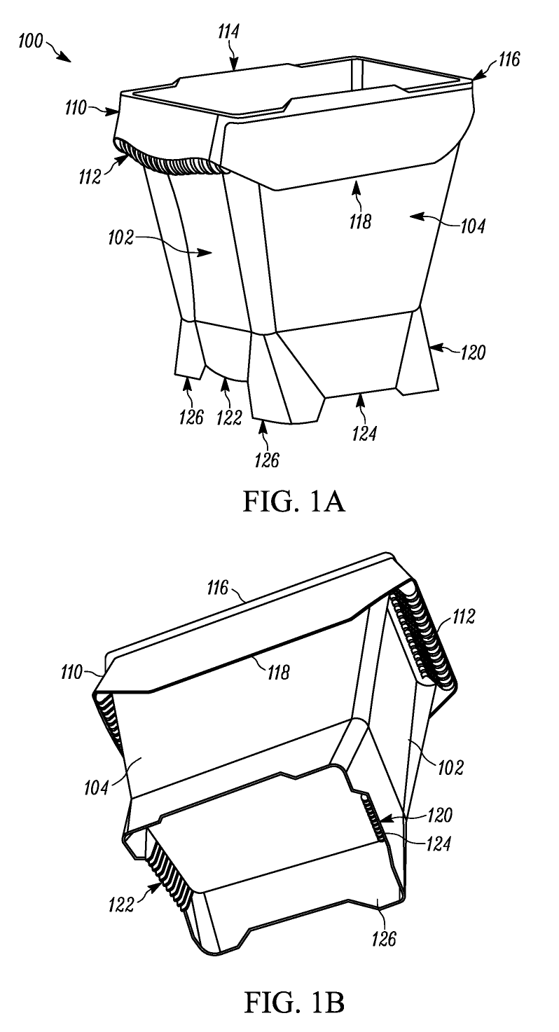

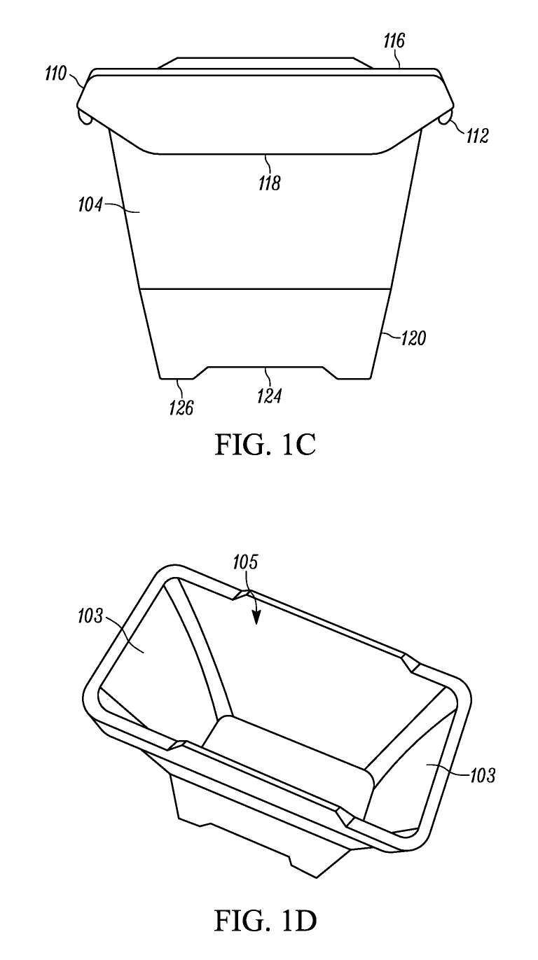

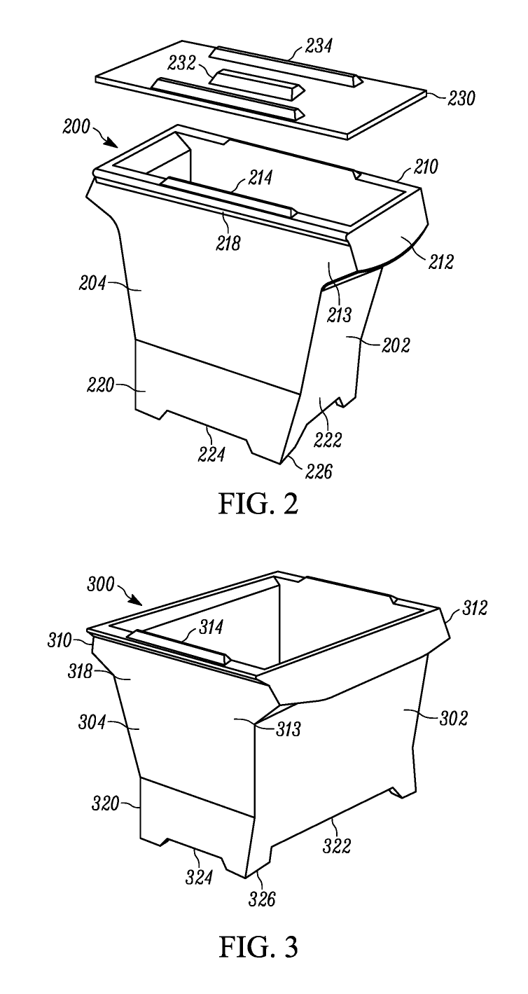

Similar features shown in the different embodiments illustrated in the figures above share similar reference numbers. Each element has a three-digit reference number, with the first digit representing the embodiment number and the last two digits representing the component. For example, element 112 is a handle in FIGS. 1A-1D and element 212 is a handle in FIG. 2. Other than the differences explicitly described and/or shown, elements with corresponding elements are understood to be substantially similar.

### DESCRIPTION OF THE INVENTION

Many variations of ergonomic waste receptacles are discussed herein and even further are contemplated in view of this disclosure. The receptacles discussed herein are configured, and designed, to control the amount of organic waste deposited in same, reinforce the receptacle to prevent distortion of same from stored solid waste and to allow the receptacles to be securely stacked on top of one another, provide features for reducing the smell associated with same and making the receptacle easier to clean with equipment commonly found in retail establishments, provide numerous features to allow for easy lifting and dumping of the receptacle (while maintaining a smooth interior that can also be easily cleaned), and features that make the receptacle easier to transport and more appealing in cases where it has to be transported through areas where customers are present. In many applications, it is also desirable to stack the receptacles for easy storage (with or without a cover or lid being present on the lower receptacle) and to provide a plurality of ways in which the purpose or use of the container may be identified to ensure proper usage.

FIG. 1A shows a perspective view of an exemplary ergonomic waste receptacle 100 in accordance with one embodiment of the invention. The ergonomic waste receptacle 100 includes a top portion 110, a pair of end walls 102, a pair of side walls 104, and a bottom portion or base 120. In a preferred form, the top portion 110 extends around the upper portions of the end walls and side walls 102, 104 and structurally reinforces the walls of the container to hinder bowing of the receptacle walls under the weight or load of organic waste. The top portion 110 illustrated forms a frame or skirt member extending about the perimeter of the receptacle opening and has handles 112 integrally formed therein. More particularly, in the form illustrated, top portion 110 forms integral handles 112 positioned proximate (e.g., adjacent) the end walls 102 and forms a pair of structural fins 118 proximate the side walls 104, a top lip 116, and upward protrusions 114 to aid in stacking. In a preferred form, the top lip 116 has minimal surface area so that it does not serve as a surface on which debris can come to a rest. The structural fin 118 connects the two top end handles 112 to reduce the amount that they bend outwards when the receptacle is lifted. The structural fins 118 also serves to prevent the top of the receptacle 100 from deforming when full. If the receptacle 100 were to deform it would not properly stack with other receptacles 100 and the lid would not properly seal. The structural fins 118 can also serve as additional handles when lifting the receptacle 100. In some forms, the fins 118 may be designed to provide a lip that runs uninterrupted on each side of the receptacle. In other forms, however, this lip may hide numerous webs or ribs that connect the fin 118 to the side walls 104 of the receptacle or container 100.

The receptacles 100 can be made from any desired material using any desired manufacturing process (e.g., stamping, pressing, molding, etc.). In a preferred form, the receptacles 100 will be made of any rigid or semi-rigid plastic including, but not limited to, acrylonitrile butadiene styrene (ABS), high density, medium density, or low-density polyethylene, polystyrene, polycarbonate, polyetherimide, or polypropylene. Similarly, the plastic receptacles 100 can be formed using any suitable molding process (e.g., injection molding, rotational molding, blow molding, etc.). The receptacle 100 may also be made in a variety of colors in order to indicate different types of waste. For example, green receptacles 100 for organic waste, blue for recyclable waste, grey for garbage, etc.

In some applications, the ergonomic waste receptacle 100 can be used with a lining bag. The top end handles 112 and the structural fins 118 form a lip onto which the top of a bag lining the receptacle 100 can attach. Wrapping the top of the bag around the top end handles 112 and the structural fins 118 prevents the bag from falling completely into the receptacle 100 which can cause organic waste to get onto the receptacle 100 and the outside of the bag and acts as a strain relief when the bag is under load.

In some embodiments, the upper portion 110, end walls 102, and/or the side walls 104 include an area on which an embossed trademark or sticker showing a trademark can be placed. Alternatively, the trademark displaying area could be on the lid 130 described below.

As shown in FIG. 1B, the base 120 includes a pair of bottom end handles 122, a cart interface 124 and four feet 126. In the embodiment show, the cart interface 124 is an opening between the feet 126 on each side that is sized to fit over a rail of the cart. The cart interface 124 can also serve as additional handles when lifting the receptacle 100. In some embodiments, the base 120 is detachable from the rest of the receptacle 100. The base 120 is held onto the receptacle 100 by a fastener, such as a friction fit or snap fit configuration (but other fasteners such as interlocking members, screws, bolts, clasps, etc. may be used). Removal of the base 120 allows for easier cleaning of the receptacle 100 such as in a commercial mop basin or sink, with a commercial dish washer, etc. The base 120 has a trapezoidal cross section in order to increase stability. In a preferred form, the base 120 is also shaped to receive the upward projections 114 of a second receptacle in order to aid in stacking. It should be understood that other forms of mating structures may be used to mate the base with the receptacle and to mate one receptacle to another when stacked (e.g., mating the base of one receptacle to the upper portion 110 or stacking aids 114 of another receptacle. It should also be understood that in other embodiments the base 120 may be integrated into the receptacle 100 as a whole rather than being a separate structure (if desired).

Both the top end handles 112 and the bottom end handles 122 are ergonomically designed to include contours that fit comfortably into a hand. The end handles 112 and base handle 122 are preferably slotted so that they can be gripped without slipping. In some forms, the receptacle 100 may be designed with openings in the top surface proximate the handle in order to provide additional gripping surface area and/or to allow the container to be lifted or pulled by gripping same overhanded instead of underhanded.

In operation, the ergonomic waste receptacle 100 is kept in a kitchen or grocery store so that it can be used to collect organic waste. Periodically the receptacle 100 is emptied into a composing dumpster. In order to empty a heavy receptacle 100 into a dumpster, the receptacle 100 can first be lifted by the top end handles 112 and/or a combination of an end handle 112 and the side skirt member or fin 118 or the base handle 122. As can be seen in FIG. 1C, the top end handles 112 protrude out further than the structural fin 118 at the ends. Because of this one of the top end handles 112 can be placed over the rim of the dumpster to serve as a fulcrum or pivot point to assist with dumping the contents of the receptacle. As the top end handle 112 rests on the dumpster, the user can move their hand in order to re-grip the receptacle 100 by the bottom end handles 122. With the lower grip, the receptacle 100 can be lifted higher in order to dump into the dumpster.

Turning to FIG. 1D, the interior surface 103 of the end walls 102 and the interior surface 105 of the side walls 104 are smooth and continuous, meaning there are not catches, protrusions or cubbies/spaces in which waste can become trapped. In some existing organic waste receptacles, the handles are built directly into the end walls, resulting in ledges on the interior surface on which organic waste can rest and become trapped. By having the top end handles 112 instead be part of the top portion 110, there are no hang-ups on the interior surfaces 103/105. The lack of ledges or crevices allow for the receptacle 100 to be easily cleaned. In the present embodiment the walls 102/104 are sloped or tapered so that the bottom of the receptacle 100 has a smaller cross section than the top. In alternative embodiments, the walls 102/104 may be more vertical so that the cross section of the receptacle remains generally constant (perhaps with a slight taper to accommodate plastic injection molding needs). In other alternative embodiments, either the end walls 102 or the sidewall 104 may be sloped, while the other pair of walls are vertical. In the form illustrated, the end walls 102 extend inward toward the cavity of the receptacle to provide sufficient spacing for handles 112. Thus, in FIG. 1D there is shown a slightly convex shape to the interior 103 of end walls 102.

FIG. 2 illustrates an ergonomic waste receptacle 200. The receptacle 200 differs from the receptacle 100 in that the structural fin 218 is much shorter than the structural fin 118. The structural fin 218 reinforces the top edge of the receptacle 200 to prevent the side walls 204 from bowing out under the pressure of a full load. The structural fin 218 further provides a finger hold that can be used to lift the receptacle 200. However, the structural fin 218 does not reinforce as much of the top end handles 212 as fin 118 does in FIGS. 1A-D. Instead the top end handles 212 are attached to the side walls 204 by handle walls 213. The handle walls 213 reduce the amount by which the top end handles 212 bend when a heavy receptacle 200 is lifted. In some embodiments, the handle walls 213 can be cut out or placed high enough so that the top end handles 218 can hang over the top of a dumpster as described above in FIG. 1C.

The ergonomic waste receptacle 200 further comprises a lid 230. The lid 230 includes a handle 232 and upward projections 234. The handle 232 provides an easy grip point by which to attach or remove the lid 230 and is preferably integrally formed into the lid or cover 230. This allows for the edges of the lid 230 to be flush with the top of the end walls 202 and side walls 204. The handle 232 is also more sanitary, as lifting the lid by the edges may result in getting organic waste on the hands of the user. The lid 230 is movable between a first position and a second position. In the first position the lid 230 is remote from the receptacle 200. In the second position, the lid 230 is attached to the receptacle 200. The upward projections 234 interact with the base 220 of a second receptacle 200 in order to aid in stacking. In the embodiment shown, the upward projections 234 are hollow so that they can receive the upward projections 214 of the upper portion 210 of the receptacle 200. The upward projections 214 of the upper portion 210 can be configured to snap fit into the upward projections 234 of the lid 230 in order to securely attach the lid 230 to the receptacle 200. The lid 230 forms a seal when attached to the receptacle 200 in order to trap in odor and keep out insects and other pests.

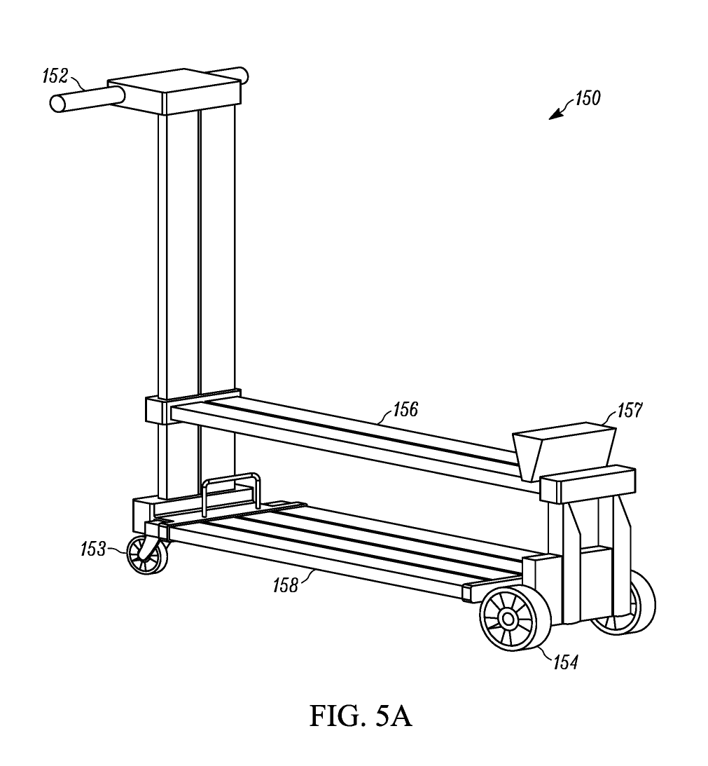

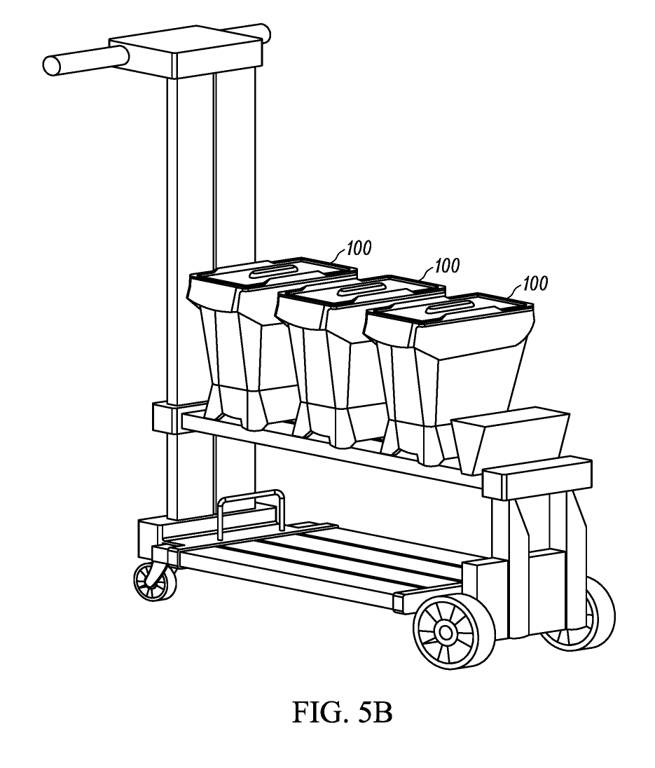

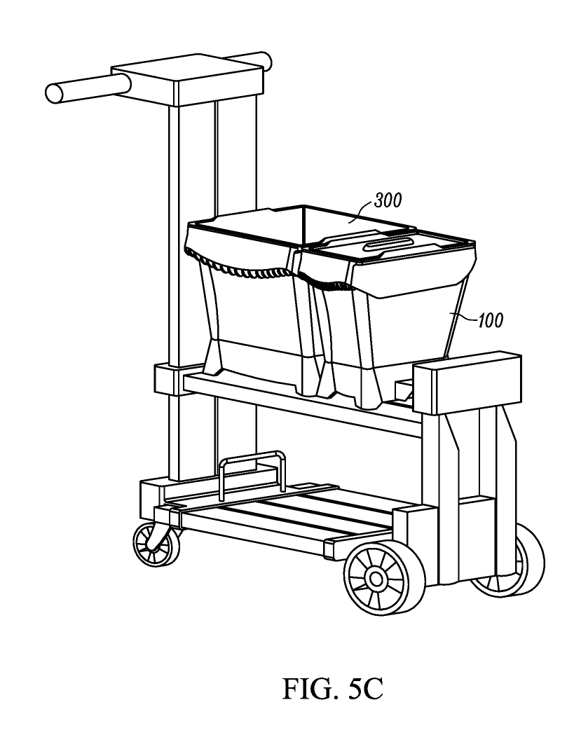

FIG. 3 illustrates an ergonomic waste receptacle 300. The receptacle 300 is substantially similar to the receptacle 200 except it is twice as wide. The double-wide receptacle 300 includes a pair of end walls 302, a pair of sidewalls 304, a top portion 310, and a base 320. The top portion 310 includes a pair of top end handles 312, upward protrusions 314 to aid in stacking, and a structural fin 318. As in the second embodiment, the structural fins 318 are a short rims that reinforce the side walls 304 against bowing. The structural fins 318 also provide finger holds to be used when lifting the receptacle 300. The top end handles 312 are attached to the side walls 304 by handle walls 313 in order to reinforce the top end handles 312 against bending under the weight of the receptacle 300 when lifted. In alternative embodiments, the structural fins 318 can be larger and attached directly to the top end handles 312 as in the receptacle 100. The base 320 includes lower end handles 322 and a cart interface 324. The cart interface 324 is substantially similar to the cart interfaces 224 and 124 described above. As such, all three receptacles 100/200/300 can be transported by the same cart (see FIGS. 5A-5C below).

In operation, the ergonomic waste receptacle 300 can be used in applications where the waste is less dense than those applications in which the receptacles 100 and 200 are used. For example, the receptacle 300 could be used in the bakery section of a grocery store or for bread products in a restaurant, while the smaller receptacles 100 and 200 are used for denser waste such as meat, vegetables, and fruit. The larger receptacle 300 could also be better suited for applications where either the waste decomposes slower or where a larger quantity of waste is produced. Food that decomposes slower can be kept in the receptacle 300 for longer periods of time without posing a health hazard, thus a larger receptacle 300 that needs emptied less often can be used. Alternatively, for applications with a high rate of turnover a smaller receptacle 100/200 would need emptied too frequently and would slow down work being done. As such a larger receptacle 300 would be more economical.

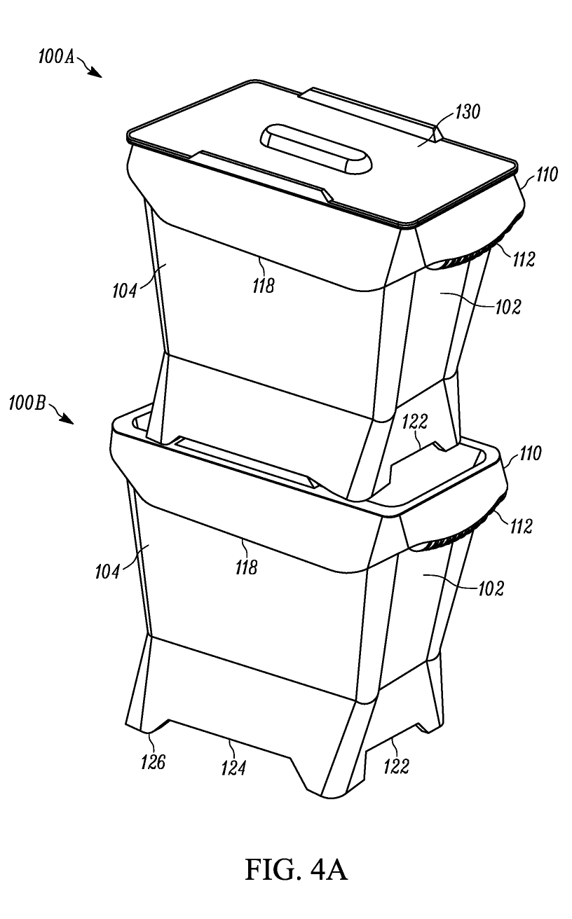

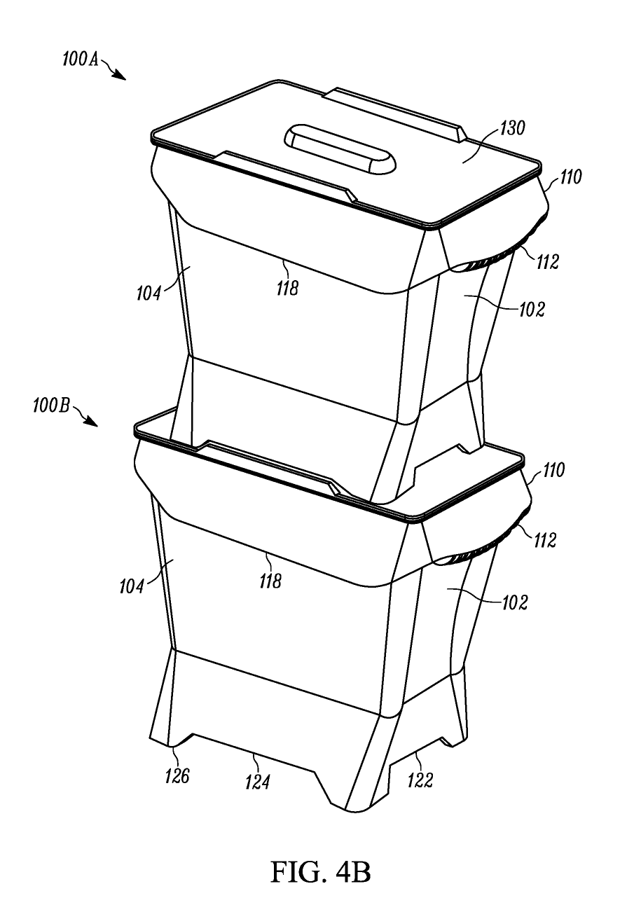

FIGS. 4A and 4B show stacks of ergonomic waste receptacles 100. The legs 126 of the top receptacle 100A fit tightly around the upward projections 114 of the bottom receptacle 100B. As such, the top receptacle 100A is prevented from sliding in any horizontal direction relative to the bottom receptacle 100B. In FIG. 4A the bottom receptacle 100B does not have a lid. However, in FIG. 4B the bottom receptacle 100B does have a lid 130. The lid 130 has upward protrusions 134 that fit over the upward protrusions 114 on the upper portion 110 of the receptacle 100B and interact with the base 120 of the top receptacle 100A in order to prevent the receptacles 100 from sliding horizontally relative to each other. The lid 130 further includes a handle 132 in order to aid in attaching and removing the lid 130 to the receptacles 100. The other receptacles 200/300 can be stacked in the same manner as the receptacle 100. Additionally, as the receptacles 100 and 200 are the same size, they can be stacked with each other with the upward projections 114 interacting with the base 220 and the upward projections 214 interacting with the base 120.

In the present embodiment, the receptacles 100 are sized such that a stack of two receptacles 100 fit underneath a standard 36 inch (36″) countertop used in most commercial kitchens. Specifically, the receptacles 100 are about 16 inches to 17.5 inches (16″ to 17.5″) tall and 19 inches to 21 inches (19″ to 21″) long. The size of the receptacles 100 can vary based on the application.

FIGS. 5A-5C illustrate a low-profile cart 150 for use in conjunction with the receptacles 100/200/300 discussed above. The cart 150 includes a handle 152, a first set of wheels 153 (front or rear wheels depending on the direction of travel the cart is being used in), a second set of wheels 154 (again rear or front wheels depending on the direction of travel the cart is being used in), a first shelf or rail 156 for holding receptacles and a second or bottom shelf 158. In some embodiments the rail 156 may include a locking mechanism or stop 157. The stop 157 can be adjusted along the rail 156 so that it can lock receptacles against the handle 152 to prevent them from sliding. The stop could be configured to be manually operable or automated. For example, in one form a manual stop may be moved, such as slid, between a released or unlocked position where it is not engaging the receptacles stored on rail 156 and a second position wherein it engages the receptacles on the rail 156 and secures them to the cart 150. In a preferred form, the stop has an integrated lock or brake and actuator that is movable between a first unlocked position where the stop 157 is freely movable about the rail (at least linearly) and a second locked position where the brake secured the stop 157 in the selected position on the rail 156. In a preferred form the break and actuator of the stop and the stop and rail 156 will operate similar to conventional bar clamp mechanisms do for securing items. The actuator could be positioned on the stop 157 or positioned proximate the handle 152. For example, in the latter embodiment, multiple actuations of a lever position proximate the handle 152 may be used to advance the stop 157 toward receptacles on the rail 156 to clamp the receptacles between the stop and the upright portion (e.g., vertical column) that the handle 152 is connected to in order to secure the receptacles between the stop 157 and the handle 152. In alternative embodiments, the stop 157 can be spring biased so that it automatically clamps or holds the receptacles 100 against the upright portion or vertical column containing handle 152.

The rail 156 is sized to fit within the cart interface 124/224/324 of the receptacles 100/200/300 discussed above. The cart interfaces 124/224/324 consist of recesses in the base configured to fit over or receive the rail 156. The rail 156 is wide enough so that the receptacles 100/200/300 will be stable if placed on the rail 156 without the bases 120/220/320. In the present embodiment, the rail is 30 inches long. The single wide receptacles 100/200 are about 9 inches to 10 inches wide so that three of them or one single wide receptacle 100/200 and one double wide receptacle 300 can fit on the cart 150. In alternative embodiments, the rail is forty inches (40″) long to accommodate four (4) single wide receptacles 100/200, two (2) double wide receptacles 300, or a combination thereof. The rail 156 is raised up so that the receptacles 100/200/300 are at a more comfortable height for working in and lifting. Not having to bend to pick the receptacles 100/200/300 off of the ground reduce the risk of possible back injury from improper lifting form. The height of the rail 156 can be set so as to allow a cart 150 with receptacles 100 to fit under a standard counter top, or in order to set the top of the receptacles 100 to be coplanar with or slightly lower than a standard table height, such as a prep table, so that the receptacle can be positioned slightly under the top of the table (e.g., overlapped) so that food product can be slid off the table and into the receptacles more easily. In a preferred form, the rail 156 positions the receptacle resting thereon at the same height it would be if it were alternatively connected to another receptacle such as shown above with respect to stacked receptacles.

The raised rail 156 also allows room for a bottom shelf 158. This may be of particular interest in applications where store associates or workers need a place to rest additional items that have to be taken out to the garbage or recycling dumpsters. For example, in some applications the receptacles 100/200/300 may be used by store associates working in the product section of a grocery store. In these situations, the store associates can bring a box of fresh produce out to restock produce displays (carrying the box on top of the receptacles stored on the cart 150. The associate can discard the old food that has to be removed from the display into the receptacle while replacing with the new product. Once the box of fresh product or food product is empty it can be broken down and placed on the shelf 158 so that the associate can take both the organic waste in the receptacles and the broken down box material out to the store's recycling area, dumpsters, etc. The cart 150 may further include a fastener for securing the items stored on the lower shelf 158, such as a clamp for clamping the items between a first jaw of the clamp and the upper surface of the lower shelf 158 (essentially using that surface as the second jaw of the clamp). In other forms, the fastener may be a spring or elastic tension device (e.g., a bungee cord, spring, etc.) for wrapping around at least a portion of the stored item to secure same to the lower shelf 158.

In alternative embodiments, the rail 156 may be placed lower such as where the bottom shelf 158 is in the FIGS. This would lower the center of gravity of the loaded cart 150, and would make it easier to place a heavy receptacle 100/200/300 on the rail 156 since it would not be needed to be lifted as high. In a preferred form, such a configuration could be designed so that the low-profile cart allows the dual stacked receptacles to continue to slide under a table or countertop surface to allow food to be slid off of same and into the receptacle. In other alternative embodiments, the bottom shelf 158 is replaced with a second rail 156. This would allow for two rows of receptacles 100/200/300 to be loaded onto the cart 150. The receptacles and cart could also be designed with a mating structure to mate the receptacles to the cart to secure them to same if desired.

The first set of wheels 154 (e.g., front or rear wheels 154 depending on the direction of travel the cart is being used in) are mounted such that they can rotate when the cart 150 moves, but cannot pivot when the cart turns. Conversely, the second set of wheels 153 (e.g., rear or front wheels 153 again depending on the direction of travel the cart is being used in) can pivot, allowing the cart 150 to turn. The bottom shelf 158 can be used to hold other items that need to be transported along with the receptacles, such as lids 130/230/330, spare liner bags, cleaning supplies, other equipment for use in a particular application the cart and receptacles will be used in such as plastic gloves for handling produce, etc.

In an alternative embodiment, the cart 150 includes a lift mechanism, such as a jack, counterbalance system, pivot mechanism or scissor lift mechanism, to raise the loaded receptacles 100 up either to dumpster height or closer to dumpster height to minimize the amount of lifting required of an associate or worker. This aids in the emptying of the receptacles.

In operation in a restaurant or other commercial kitchen, full receptacles 100 from a kitchen are loaded onto a cart 150 and wheeled to a composting dumpster or other waste collector. The receptacles are then gripped by a combination of handles 112/122 and lifted up to the rim of the dumpster. One top end handle 112 is hooked over the rim of the dumpster, and the receptacle 100 is tilted to dump its contents into the dumpster.

In operation in a grocery store, empty receptacles 100 are loaded onto a cart 150. The cart is then wheeled throughout the store, or throughout a section of the store, and an associate removes expired, spoiled, damaged, or otherwise undesirable products from the displays and places them in the receptacles 100. Once the receptacles 100 are full they can be wheeled out to a dumpster or other waste collector and emptied in the method described above.

While the receptacle or containers disclosed herein have been designed with unique features that help solve some of the above-identified problems associated with conventional containers, it should be understood that the actual designs used or implemented in those features and the above embodiments are merely one way of implementing the contemplated concept or solution. Numerous other designs could be conceived, selected and used to perform the same function, operate in the same way and/or achieve the same result. For example, while the handles 112 are useful to engage the upper lip of a dumpster, the handle designs disclosed herein are merely one way in which those handles could be designed to allow for this functionality and, thus, are not the only way this concept or feature can be implemented. Thus, it should be understood that the below claims are intended to encompass numerous different embodiments and ways in which these concepts can be implemented.

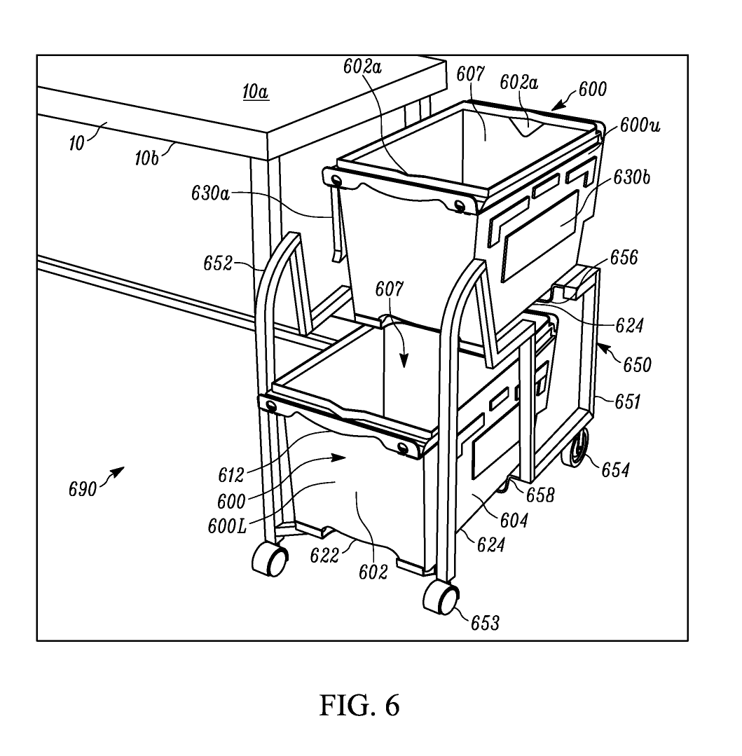

FIG. 6 illustrates a waste receptacle system 690 comprising at least one receptacle 600 and a cart 650. The receptacle 600 has upper ergonomic handles 612 located proximate the top of each end wall 602. Similar to the previous embodiments, the handles 612 preferably extend out from the end walls 602, as opposed to being recessed in the end walls 602, so that the inner surface of the end walls 602 remain smooth and free of ledges. This makes the receptacles 600 easier to clean. Half of a lid 630a/630b is hingedly attached to the top of each sidewall 604. In one form, the first and second lid sections 630a/630b are configured to snap together when in a closed position to secure the receptacle 600 closed. In alternative embodiments, other locking mechanisms are used. For example, a sliding member movable to project from the first lid section 630a and be received in a recess or aperture in the second lid section 630b.

The receptacles 600 include two lower pairs of handles, e.g., lower end handles 622 and lower side handles 624. The end handles 622 and side handles 624 are ergonomically shaped, making the receptacle more comfortable to lift and maneuver from any side. In some forms, the lower handles 622, 624 form recesses in the bottoms of the end walls 602 and sidewalls 604, respectively. The recesses can be sized to fit over a horizontal bar, such as the rail 156 described above in FIGS. 5A-C, but in a preferred form, the handles 622, 624 are recessed to provide sufficient clearance for a user to place their hand in under the container and lift from any side thereof regardless of whether the receptacle 600 is resting on a flat surface or stacked on another receptacle 600.

The end walls 602 and sidewalls 604 of the receptacles 600 are tapered inward such that the bottom of the receptacle has a smaller cross section than the top of the receptacle. In one form, the taper is slight, for example less than five degrees (5°). The slight taper aids in the injection molding process without sacrificing much storage capacity and makes the receptacles 600 capable of being nested in one another to reduce the size of multiple containers stacked and nested together (e.g., a stack and nest container configuration). More particularly, in some forms, the walls 602/604 are tapered such that the bottom of a receptacle 600 is sized to be received in the opening 607 of a second receptacle 600 and capable of being inserted well into the opening 607 (e.g., more than fifty percent (50%) into the other container and preferably between fifty and ninety-eight percent (50%-98%) within the other container), enabling them to be nested for storage and/or shipping purposes. In a preferred form, the end walls 602 contain tapered or funneled guides 602a for guiding drainage of the container/receptacle 600.

The cart 650 includes a frame 651, two fixed wheels 654, and two swiveling wheels 653, such as swivel casters. The wheels 654, 653 are coupled to the bottom of the frame 651 of the cart 650 and the frame is preferably made of a hollow or tubular construction (e.g., in a preferred form, a tubular construction with a substantially rectangular cross-section). A lower compartment or support 658 is sized and configured to receive and support a lower receptacle 600L. An upper compartment or support 656 is sized and configured to receive and support an upper receptacle 600U. In one form, the supports 656/658 comprise a recess in the upper and lower parts of the frame 601, respectively, defined by one or more horizontal members on which the receptacles 600 rest. The horizontal members are at least partially surrounded by a generally vertical rim or flange for reducing horizontal movement of the receptacles 600, thus reducing the likelihood of a receptacle 600 being knocked off the cart 650. In alternative embodiments, the supports 656/658 include horizontal members sized to be received in the recesses in the bottom surface of the receptacles 600 formed by the bottom end handles 622 or bottom side handles 624.

The cart 650 is longer than a receptacle 600. In one form, the cart 650 is between twenty-five percent (25%) and fifty percent (50%) longer than the receptacle 600. For example, if the receptacles 600 are twenty inches (20″) to twenty-four inches (24″) long, the cart 650 is twenty-five inches (25″) to thirty-six inches (36″) long. Thus, the exposed portion of the top of the lower receptacle 600L is five inches (5″) to twelve inches (12″). More particularly the exposed top may be five inches (5″) to nine inches (9″) long. In one form, the cart 650 is twenty-nine inches (29″) long and the receptacles 600 are twenty-two inches (22″) long, such that seven inches (7″) of the interior opening 607 of the lower receptacle 600L is exposed. The two receptacles 600U, 600L are staggered such that one receptacle 600L is proximate the first end or handle 652 end of the cart 650, and the other receptacle 600U is proximate the second, opposite end of the cart 650. Staggering the receptacles 600 exposes a portion of the interior 607 of the lower receptacle 600L when the upper receptacle 600U is in place. A user can thus add material to or remove material from the interior of the lower receptacle 600L without needing to move the upper receptacle 600U. In a preferred form, the lower receptacle 600L is proximate the handle 652 end of the cart 650. A user standing proximate the handles 652 can access both receptacles 600. Thus, cart 650 could be positioned the end of a prep table in a kitchen and scraps can easily be dropped from the table into both the upper and lower containers 600U, 600Lwithout the need to remove the receptacles 600 from the cart 650. In this manner, the user can simply move the receptacles to a composting dumpster when the receptacles 600 are filled without having to put them on the cart for transport.

The handles 652 are generally D shaped and formed of a bend in the square tubing forming the frame 651 of the cart 650. The curve of the handles 652 is ergonomically designed to make the cart 650 more comfortable to operate and agnostic so that different sized people can grab the handles 652 where most comfortable to them.

In a preferred form, the cart 650 is formed of an easy to clean material. For example, the cart 650 is formed of a smooth metal, such as aluminum or stainless steel. Similarly, the receptacles 600 are formed of smooth plastic to aid in cleaning.

The table 10 is a standard height table or counter. For example, the table 10 has a top surface 10a having a height between thirty-two inches (32″) and thirty-six inches (36″). The cart 650 and receptacles 600 are sized and configured such that the top surface of the upper receptacle 600U is at or below the top surface 10a of the table 10. This enables a user to slide material off of the top surface 10a of the table 10 into the upper receptacle 600U. In a preferred form, the top of the upper receptacle 600U is lower than the bottom surface 10b such that the cart 650 and receptacles 600 can be nested beneath the end of the table 10 or stored below the table 10 when not in use. For example, the total height of the cart 650 with an upper receptacle 600U is less than thirty-one inches (31″). Nesting the receptacles 600 partially underneath the table 10 is more sanitary, as it lowers the risk of waste falling between the table 10 and the receptacle 600 when being slid off of the table 10. In addition, real estate in kitchens (like other work spaces) is at a premium and, thus, being able to store the carts 650 and receptacles or containers 600 below the tables 10 when not in use conserves space in the kitchen, and thus, makes better use of same.

In operation, the cart 650 is provided having the staggered supports or compartments 656 and 658. A lower receptacle 600L is positioned in the lower compartment (or on the lower support) 658 and an upper receptacle 600U is positioned in the upper compartment (or on the upper support) 656. The cart 650 is then positioned proximate a table 10, such as a kitchen prep table, so that waste can be quickly transferred from the table 10 to either receptacle 600L, 600U. When the receptacles 600 are full, the cart 650 is rolled to another location for storage or disposal. The receptacles include lids 630a/630b that can be closed for transport and/or storage to contain the smell of the organic waste. The lids 630a/630b collectively form a lid 630 that allows containers to be stacked atop one another (not inserted in one another) in case it is desirable to stack the containers in this manner.

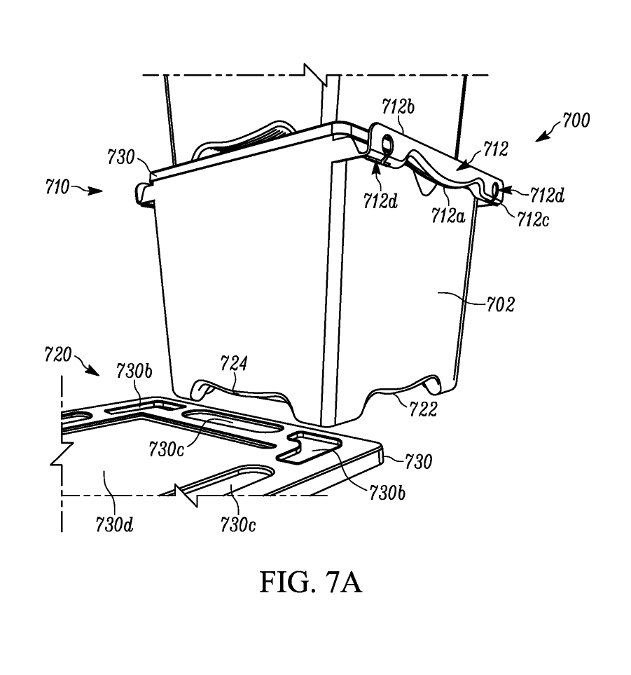

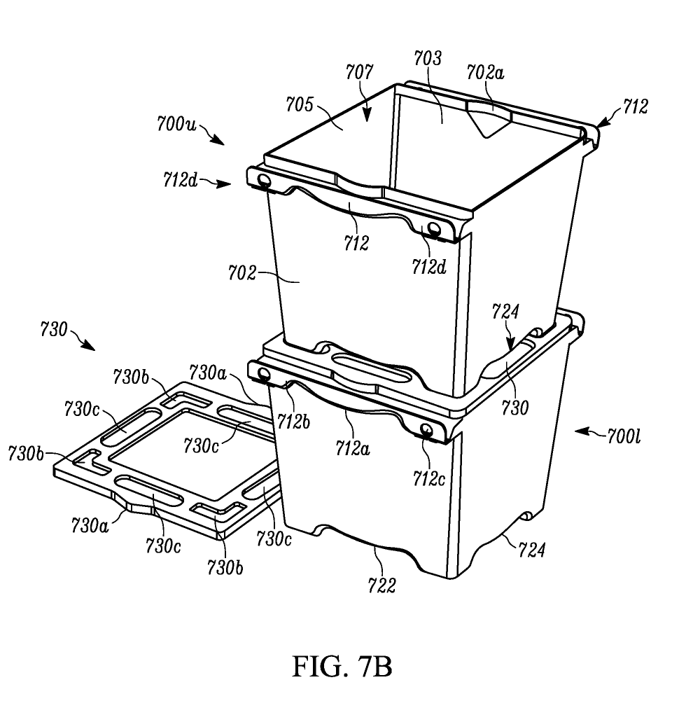

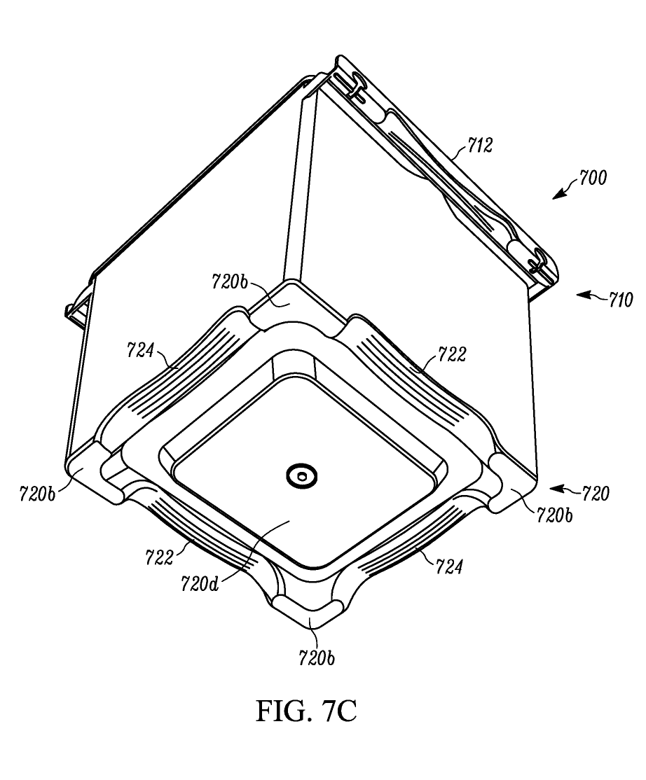

Another exemplary embodiment of a receptacle or container in accordance with the invention is disclosed in FIGS. 7A-C. In keeping with prior practice, items of this receptacle are identified using the same latter two-digit reference numeral as similar items above but changing the prefix to “7” to distinguish one embodiment from others. Thus, in FIGS. 7A-C, the receptacle is referred to generally as receptacle or container 700 and has end walls 702 and side walls 704 which define an interior cavity such as center opening 607. The upper portion 710 of receptacle 700 includes handles 712 extending from end walls 702 and the lower portion 720 includes end handles 722 and side handles 724 so that the receptacle can be grasped from any side. In the form illustrated, the lower handles 722, 724 are recessed upward into the receptacle 700 in order to provide sufficient clearance for grasping the handle even when the receptacle 700 is stacked on top of another receptacle or resting on a flat surface, such as the ground or a cart support/shelf. The lower handles 722, 724 are preferably contoured or ergonomically designed to make the comfortable and easy to grip by hand and from all sides of the receptacle. Like the prior embodiment, the end handles 712 have a curved center portion 712a and ends 712b, 712c with slots or opening 712d which allow the receptacles to be connected together via an interstitial member and/or connected to another structure (e.g., connected to a cart with mating posts that fit within openings 712d, connected to a wall member having mating posts that fit within openings 712d, suspended from a structure via mating posts 712d). In addition, the end walls 702 include tapered or funneled guides 702a, such as spouts or funnels, which are integrally formed in the end walls 702 and their respective inner surfaces 703. The fluid guide structures help direct fluid being dumped from the receptacle 700 in a desired direction.

Unlike prior embodiments, however, receptacle 700 includes a lid or cover 730 that is made of an integral one piece construction having a plurality of recesses located in the upper surface thereof which are positioned to serve as a nest or socket for receiving a corresponding portion of a receptacle stacked on top of the cover 730 and/or as a clearance for assisting users to grasp a corresponding handle or gripping portion on an adjacent receptacle stacked on the receptacle containing the cover 730. For example, in the form illustrated, the cover 730 includes corner recesses 730b which are designed to receive corresponding corner portions from the bottom portion 720 of the receptacle 700 to hinder stacked receptacles 700U from lateral movement with respect to the lower receptacle 700L. In addition, the cover 730 includes handle recesses 730c which are centrally located on the upper perimeter of the cover 730 in order to provide clearance to assist a user in gripping the bottom handles 722, 724 of the lower portion 720 of receptacle 720. The recesses 730c provide finger clearances that allow a user to reach under the upper receptacle 730U to grasp any of the lower handles 722, 724.

In a preferred form, the receptacle cover 750 will further include a large central recess 730d which is intended to receive a central protrusion extending down from the center of the bottom surface of the receptacle 700 (see FIG. 7C). In the form illustrated, the lower portion 720 of the receptacle 700 has protruding corner members 720b and a protruding central member 720d, and the recesses 730b, 730c and 730d are tapered, beveled or bell mouthed to assist in guiding the protruding exterior structures at the bottom of the receptacle (i.e., corner members 720b and central member 720d) into their corresponding recesses (i.e., 730b, 730d, respectively) to further help securely stack the upper receptacle 700U atop the lower receptacle 700L (e.g., hinder lateral movement of the upper receptacle 700U with respect to the lower receptacle 700L). This allows the upper receptacle700U to be nested on top of the lower receptacle 700L and, more particularly, on top of cover 730. The protrusions 720b, 720d extending from the lower portion of the receptacle 720 may also be tapered and/or beveled to assist with easily guiding the protrusions 720b, 720d into their corresponding recesses 730b, 730d if desired.

In the form illustrated, the cover 730 also includes an outer perimeter wall that extends down to cover around the sides of an upward extending wall of the receptacle 700 defining the opening to the center cavity 707. The cover 730 also includes protrusions 730a that correspond to the tapered or funneled guides 702a so that the cover can create a sealed engagement with the receptacle 700 which is helpful when trying to trap odors relating to the contents of the receptacle 700 in the receptacle 700 itself. A benefit to the receptacle container 700 is that by using a cover 730 that is movable between a first position wherein the cover 730 is secured to the receptacle 700 and a second position where the cover 730 is removed/detached from the receptacle 700, allows the sides of the receptacle to remain unobstructed and smooth sided surfaces without pivoted lid portions resting against same when the cover is off of the center opening 707. This allows the container to take-up a smaller footprint and, thus, the cart used with same can be made narrower if desired, or alternatively, it allows the receptacle 700 to be made wider while still fitting on the cart 650.

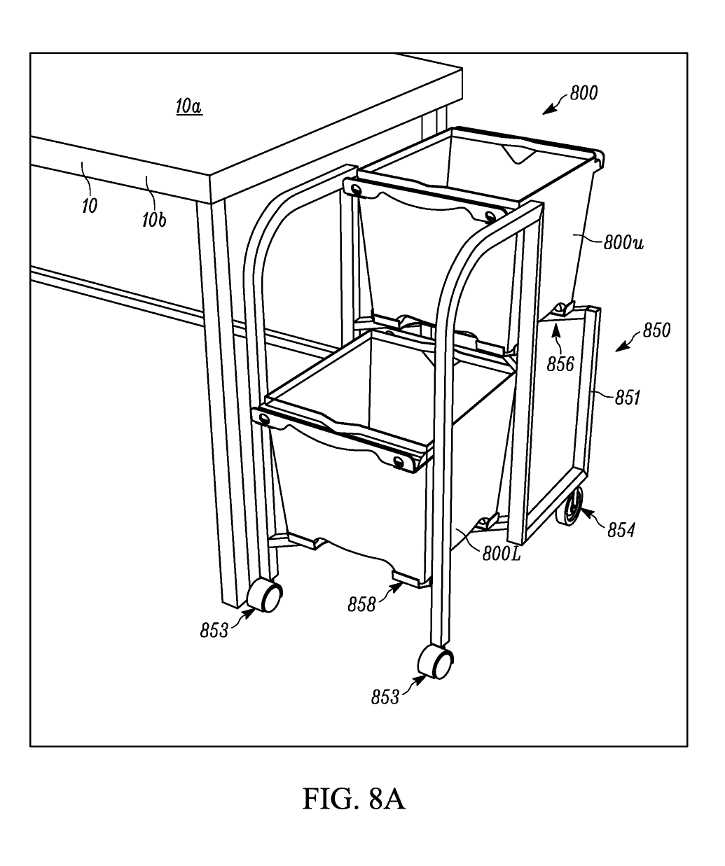

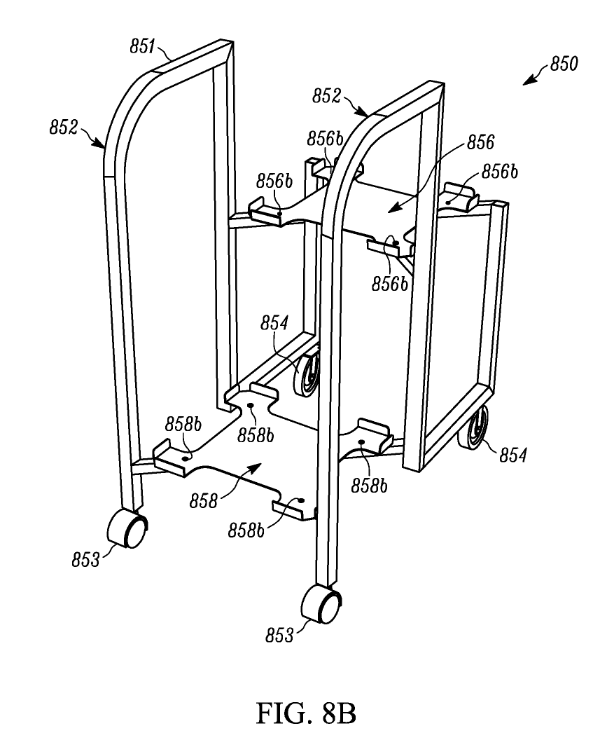

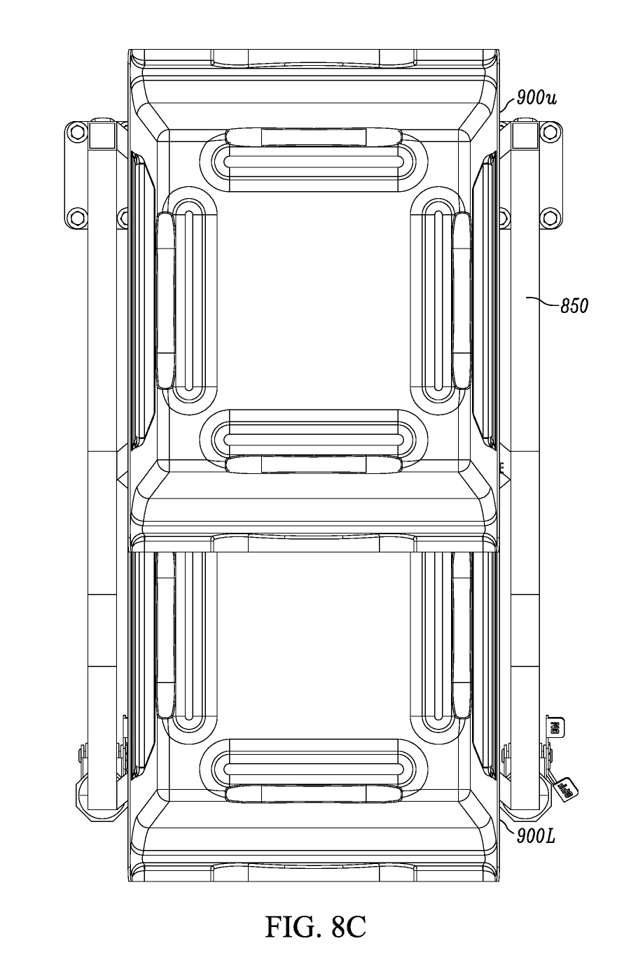

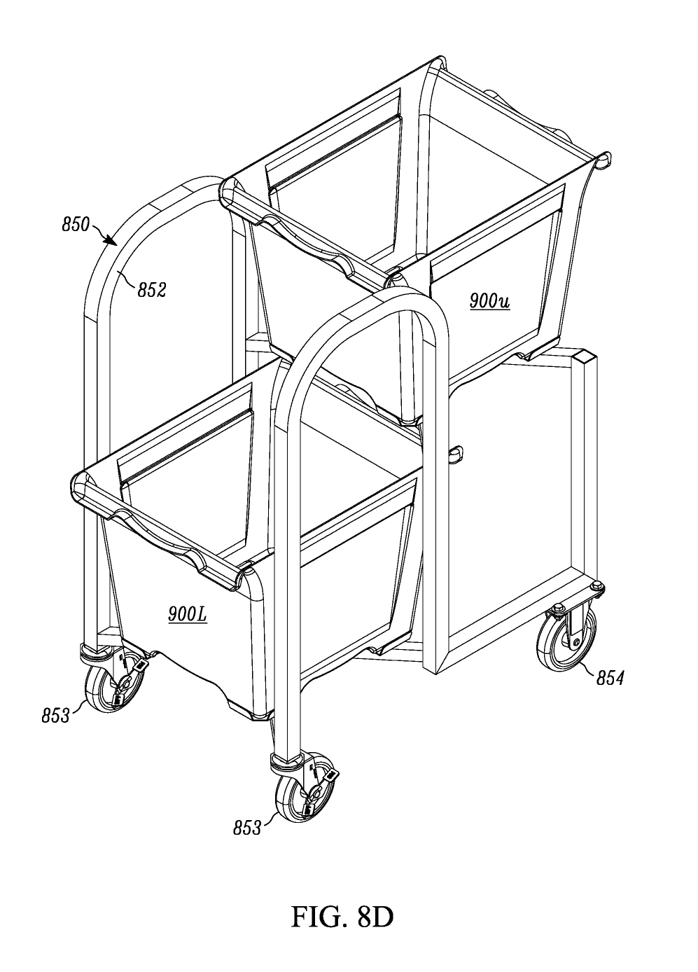

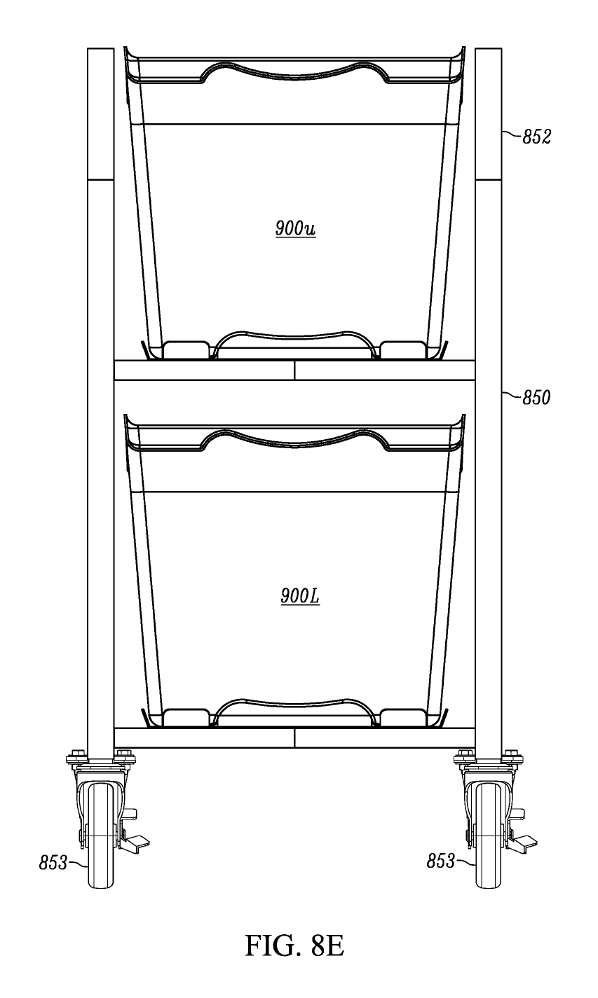

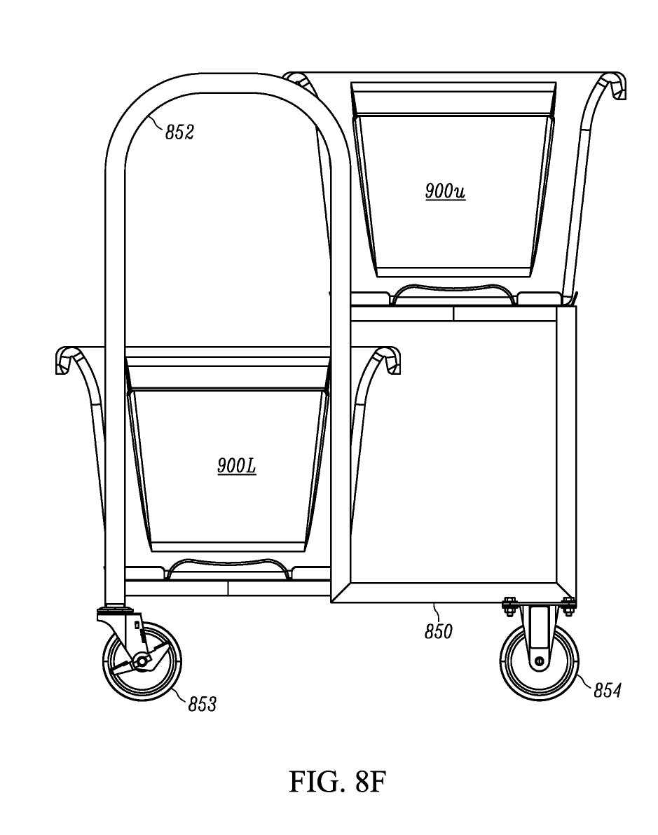

Another exemplary cart embodiment in accordance with aspects of the invention is illustrated in FIGS. 8A-F. Features of this cart that are similar to those discussed in prior embodiments will use the same latter two-digit reference numerals but will use the prefix “8” to distinguish this embodiment from others. Thus, in this embodiment an upper receptacle or container 800U is positioned on an upper support 856 of cart 850 and a lower receptacle or container 800L is positioned on a lower support 858 of the cart 850. Like prior embodiments, cart 800 preferably has a rectangular tubular frame 851 that forms curved handles 852 and positions the upper support 856 and lower support 858 within the outer bounds of the cart frame 851. The cart 850 also includes a first set of wheels or rollers, such as swivel wheels or casters 853, and a second set of wheels or rollers, such as fixed wheels 854. In a preferred form, the swivel wheels or castors 853 are positioned near or proximate the handle 852 so that the cart is easier to steer either by pushing from the handles or pulling from the handles, whichever is desired. For exemplary purposes, the relative terms used herein assume the handle is positioned at the rear of the cart and that the cart 850 will typically be pushed by handles 852. As mentioned, however, in alternate forms the cart 850 may be pulled by handles 852 making that portion of the cart technically the front when used in this manner.

While similar to cart 500, cart 800 has a more streamlined frame that does not create a bend in the handle to accommodate the upper support 856. Rather, the frame 851 of cart 850 have a distal end that rises up from first wheel set 853, transitions into a curved portion that serves as an agnostic handle portion (meaning it can be gripped in multiple positions on each side to accommodate different users, e.g., users of different heights, etc.), bends forward toward the front of the cart and then straight down and then makes another ninety degree bend forward and a final ninety degree bend upward. In this way, the tube frame forms a “5” or “S” tilted on its side (i.e., rotated counterclockwise ninety degrees 90°) with the lower curved portion of the “5” or “S” being the curved handle and the distal end opposite the end making up the lower curved portion being truncated so that it does not extend as high as the apex of the lower curved portion. Supports 856 and 858 (or bin support plates 856, 858) are formed by brackets attached to the frame 851 and include corner members 856b, 858b that support corners of the respective upper receptacle 800U and lower receptacle 800L. In a preferred form, the corner members 856b, 858b do not only have a horizontal pad portion, but also an upstanding wall extending from at least two sides of the horizontal pad portion and on the outermost perimeter of the pads so that they help retain receptacles 800 that are placed on the support pads and hinder lateral movement of same to prevent inadvertent removal of the receptacles 800 from the cart 850. Thus, the protruding corner members 820b of the lower portions 820 of the receptacles 800 are nested on the corner pads 856b, 858b of the supports 856, 858 in a similar manner to how the corner members 720b are supported in the recesses 730b of cover 730. The actual bracket structures of supports 856, 858 are best shown in FIG. 8B and have a generally or substantially X shaped axial cross-section. In a preferred form, the X shaped axial cross-section will actually have a larger center pad that taper to smaller support arms and then truncate in larger corner pads at the distal end of each arm of the X shaped bracket.

The cart 850 aligns the receptacles 800U, 800L with less of an overlap than the overlap used in cart 650 with receptacles 600U, 600L. Nevertheless, in the form shown, there is still an overlap so that a user of the cart 850 can easily move waste (e.g., organic waste) from a prep table 10 and into either of the receptacles 600U, 600L. Preferably, the cart 850 and receptacles 800 will be positionable adjacent or below the side surface 10b of prep table 10 so that they can be stored under the table 10 or positioned adjacent or partially below the table 10 so that organic waste can be moved from an upper surface 10a and into the receptacles 800. In a preferred form, the receptacle is made from a molded plastic such as an injection molded high density polypropylene, or a vacuum formed high density polypropylene.

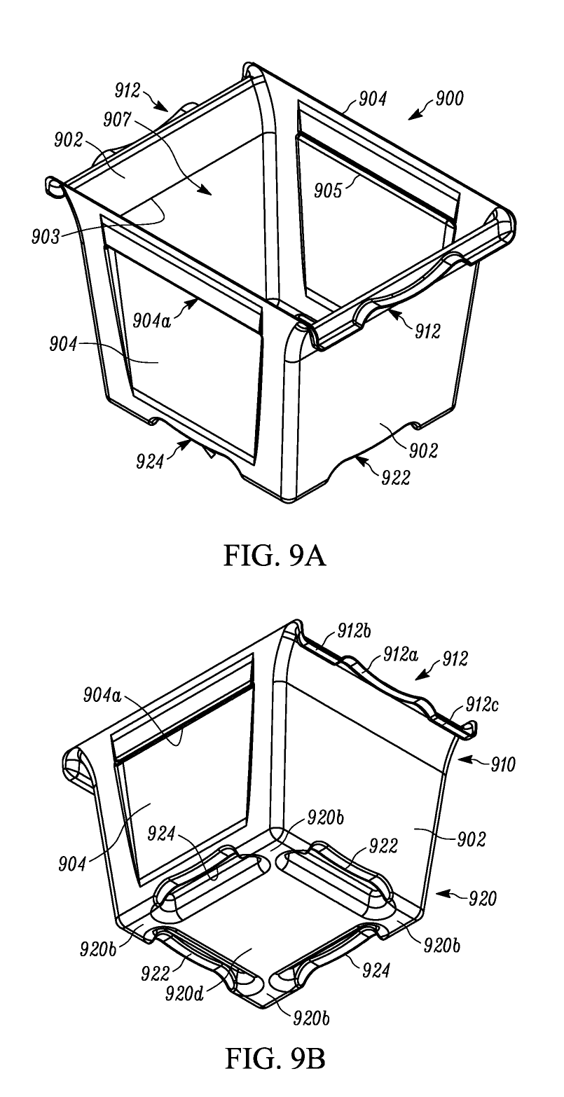

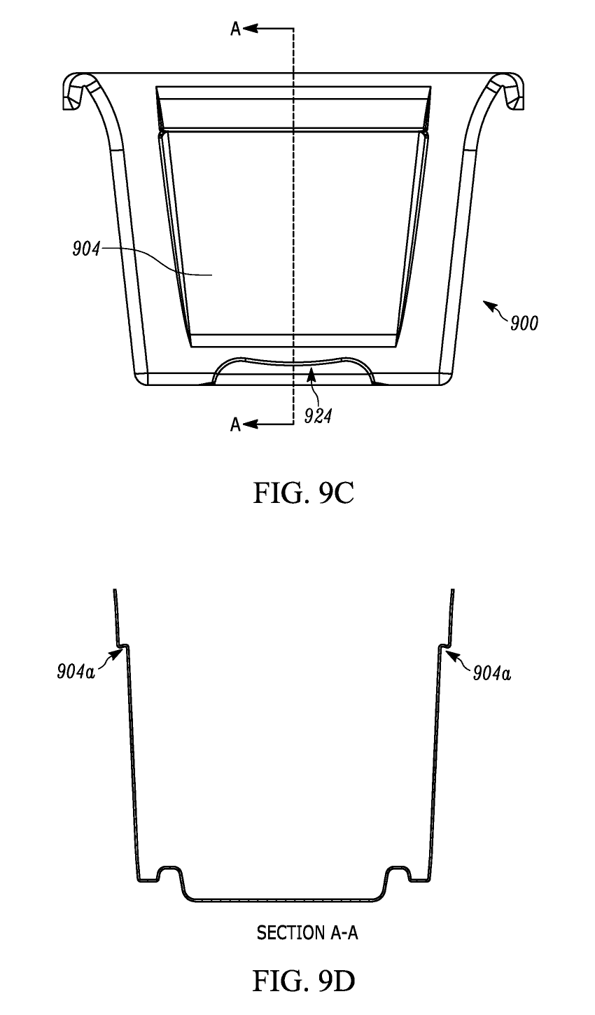

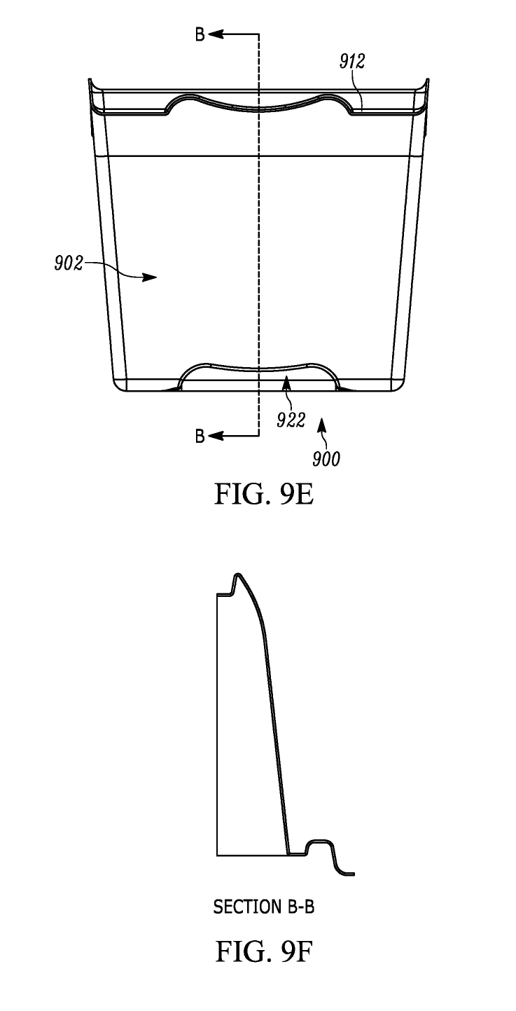

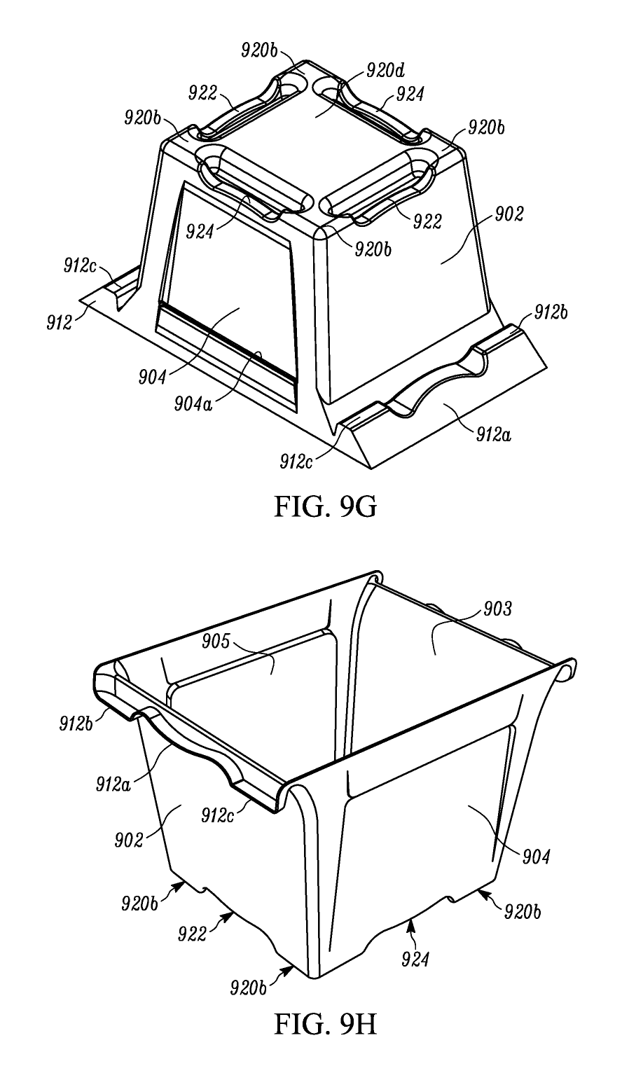

FIG. 8A illustrates the same receptacle as shown in FIGS. 7A-C, however, FIGS. 8D-8F illustrate yet another receptacle in accordance with aspects of the invention. This alternate receptacle is shown in greater detail in FIGS. 9A-G. As before, features of this alternate receptacle that are similar to those discussed previously will use the same latter two-digit reference number, but use the prefix “9” to distinguish this receptacle from prior embodiments. Thus, the receptacle is identified generally by reference numeral 900 and includes end walls 902, side walls 904 and an interior opening or cavity 907 bordered by interior end walls 903 and interior side walls 905. The receptacle 900 includes an upper portion 910 and a lower portion 920 and the lower portion has protrusions extending from the bottom of the receptacle including corner protrusions 920b and central protrusion 920d. These protrusions 920b, 920d help nest the receptacle 900 on the cover (not shown) of a second receptacle upon which the receptacle 900 is mounted. Alternatively, the protrusions 920b help retain the receptacle 900 on the bin support plates 856, 858 of cart 850.

In a preferred form, the receptacle 900 is injection molded with elongated upper end handles (as seen in FIG. 9G) that eventually get trimmed back to the handles 912 seen in FIGS. 9A-E and 9H. The handles 912 include a curved center portion 912a with first and second ends 912b, 912c, but do not include slots for connecting or securing the receptacle 900 to another structure (e.g., another receptacle, a wall, a cart, etc.). In addition, the side walls 904 include a recess that forms a lip 904a in the upper portion 910 of receptacle 900 which serves as a handle for assisting in pulling out one receptacle from another when stacked in nested fashion. The lip may also be used by automated machinery to separate stacked and nested receptacles and/or used to help remove the receptacle from the mold when formed. The receptacle 900 is preferably dimensioned to provide a substantially seven gallon (7 gal.) capacity.

Turning back to FIGS. 8C-F, the receptacle 900 can be seen mounted to the cart 850 of FIGS. 8A-8F. As with prior embodiments, the upper receptacle 900U is positioned proximate and overlapping the lower receptacle 900L. The cart includes rounded handles 852 and has forward fixed wheels 854 and rear swivel or castor wheels 852. As illustrated in FIG. 8E, the receptacles 900 are fulling contained within the outer bounds of the cart 850 in the width direction but do extend beyond the outer bounds of the cart 850 in the length direction. This allows the cart and receptacles to retain a compact configuration that can easily be stored under prep table 10 when needed in order to conserve space within a kitchen or other working environment.

Thus, receptacle 900 forms a container, bin or tote, and includes an injection molded one-piece high density polypropylene construction that may include vacuum forming if desired and in preferred forms offers a seven gallon (7 gal.) capacity which when filled with organic waste keeps the receptacle to a manageable weight that is easy enough for a user to lift when dumping into a dumpster such as a composting dumpster. In some forms the receptacle is removed from the mold and then trimmed to provide a finished product and, in particular, finished handles. The lower portion 920 of the receptacle includes handles or grips 922, 924 on all sides of the receptacle to make it easy to lift from any side or position. The receptacle 900 includes a removable lid or cover 930 which can be fully removed from the receptacle 900 rather than pivoted over to the sides of the container like what is shown with receptacle 600. This allows for the sides of the container 904 to remain smooth and free and clear of structures that could get hung-up on other structures, such as cart 850 or, more particularly, the frame 851 of cart 850. It also allows the receptacle to be made wider since space does not have to be reserved for clearance of the pivoting lid of receptacle 600 (e.g., such as the clearance required for lids 630a, 630b so that the receptacle 600 can be slid between the handles 652 and frame 651 of cart 650).

Receptacle 900 remains stackable atop one another with the cover on and/or nestable (or nest stacked) with the cover off to save space when the receptacle is not in use and/or for shipping purposes. The receptacle 900, cover 930 and cart 950 are all designed with mating or corresponding structural configurations to aide in stacking the receptacles on the cover and/or cart in such a way that hinders lateral movement of same to prevent tipping or toppling of the stacked receptacles 900. The receptacle also includes at least one tapered or funneled guide 902a for guiding removal of materials or liquids from the receptacle 900 when the receptacle is tipped or turned over. In a preferred form, the opposing end walls 902 each include such a tapered/funneled guide or spout 902a. In addition, the upper end handles 912 continue to provide a lip or surface upon which the edge of the receptacle 900 can be rested prior to and/or during dumping of the receptacle 900 into a larger receptacle, such as a dumpster.

In addition to the above-mentioned embodiments, it should be understood that a variety of methods are also disclosed herein. For example, methods of manufacturing or forming a waste container or receptacle are disclosed herein, as are methods for transporting waste containers/receptacles and methods of loading or unloading receptacles. Further methods of manufacturing or forming the devices described herein, including carts, are disclosed, as are methods of stacking and storing receptacles and carts. In one form, a method of manufacturing a receptacle is disclosed that includes injection molding the receptacle and then trimming at least one handle to produce a finished product with ergonomic handles that make it easy to lift the receptacle from all sides. A method of forming a receptacle with opposing upper handles and lower handles on each side of the receptacle. Methods of nesting containers to one another or atop one another and/or on carts are also disclosed. These and other methods related to the subject matter set forth herein are intended to be covered by this disclosure. It should also be understood that while certain features have been described with certain embodiments, these features may be intermixed or interchanged with one another to form other embodiments as desired. All features disclosed herein are intended to be used in any of the embodiments disclosed herein either in lieu of similar features or in combination with other features. For example, the handles 512 of the receptacles 500 may be configured like the handles 112 of the receptacle 100 for hooking over the rim of a dumpster. Similarly, the receptacle 100 may have a one piece configuration like the receptacle 500 instead of separable upper and lower members.

Thus, in summary, various waste receptacles and methods have been disclosed herein. This detailed description refers to specific examples in the drawings and illustrations. These examples are described in sufficient detail to enable those skilled in the art to practice the inventive subject matter. These examples also serve to illustrate how the inventive subject matter can be applied to various purposes or embodiments. Other embodiments are included within the inventive subject matter, as logical, mechanical, electrical, and other changes can be made to the example embodiments described herein. Features of various embodiments described herein, however essential to the example embodiments in which they are incorporated, do not limit the inventive subject matter as a whole, and any reference to the invention, its elements, operation, and application are not limiting as a whole, but serve only to define these example embodiments. This detailed description does not, therefore, limit embodiments of the invention, which are defined only by the appended claims. Each of the embodiments described herein are contemplated as falling within the inventive subject matter, which is set forth in the following claims.

1. A receptacle comprising:
a one-piece molded body having opposing end walls and opposing side walls interconnecting the end walls and a bottom collectively defining an inner cavity with an upward facing opening, the body having an upper portion and a lower portion;
wherein the opposing end walls have integral upper handles extending therefrom which are contoured and extend from the upper portion of the body; and
wherein the lower portion of the body defines integral lower handles defined in each side of the body so that the receptacle may be lifted from any side thereof.

2. The receptacle of claim 1 wherein the lower handles are contoured as well and the upper handles extend out from the body to define a ledge or lip that the receptacle may be rested upon prior to dumping contents of the receptacle into a larger container.

3. The receptacle of claim 1 wherein the bottom of the body defines four corner protrusions that extend from corners of the body to assist in stacking the body on another structure, with the integral lower handles being positioned between the corner protrusions and substantially centered on each side of the body.

4. The receptacle of claim 1 wherein the bottom of the body defines a center protrusion and at least one additional protrusion that extends from the bottom of the body to assist in stacking the body on another structure.

5. The receptacle of claim 4 wherein the at least one additional protrusion comprises corner protrusions that extend out from corners of the body so that the corner protrusions are located off corners of the center protrusion and together with the center protrusion the corner protrusions help nest the receptacle securely on another structure.

6. The receptacle of claim 1 wherein the end walls and side walls taper so that additional receptacles with similar tapered shapes may be nested within one another to conserve space when stored or shipped.

7. The receptacle of claim 1 wherein the upper handles define at least one slot on each handle which allow the receptacle to be mounted or secured to another structure.

8. The receptacle of claim 1 wherein upper surfaces of the end walls and side walls define a lip that forms the upper facing opening of the body and the receptacle further comprises a lid or cover that connects to the lip of the body to seal the cover to the body.

9. The receptacle of claim 8 wherein at least one end wall defines a tapered or funneled guide for directing contents of the receptacle when dumped therefrom.

10. The receptacle of claim 9 wherein the tapered or funneled guide is formed at least in part in the lip of the body and the cover has a corresponding tapered or funneled shape to allow the cover to be completely sealed to the body when the cover is connected thereto.

11. The receptacle of claim 1 wherein the side walls further define a lip or protrusion for providing a surface to lift the receptacle from when needed.

12. The receptacle of claim 1 wherein the receptacle is a first receptacle and further comprising a cover that connects to the body and seals the upward facing opening thereof when connected thereto, the cover further defining at least one recess for receiving a corresponding structure from a second receptacle when stacked atop the first receptacle.

13. The receptacle of claim 12 wherein the at least one recess comprises corner recesses located in corners of the cover for receiving corner protrusions extending from the second receptacle when stacked atop the first receptacle.

14. The receptacle of claim 12 wherein the at least one recess comprises four recesses located substantially centered on each side of the cover at a perimeter thereof for providing clearance to grasp a lower handle of the second receptacle stacked atop the first receptacle.

15. The receptacle of claim 12 wherein the at least one recess comprises corner recesses and interstitial recesses located between each corner recess with all recesses being located about a perimeter of the cover, with the corner recesses intended to receive corresponding corner protrusions extending from the second receptacle when stacked atop the first receptacle cover and the interstitial recesses forming clearances for grasping lower handles on the second receptacle when stacked atop the first receptacle cover.

16. The receptacle of claim 15 wherein the at least one recess further defines a central recess for receiving a central protrusion extending from the bottom of the second receptacle and together with the corner recesses and corner protrusions working to hinder lateral movement of the second receptacle with respect to the first receptacle when stacked thereon.

17. The receptacle of claim 1 wherein the receptacle comprises a first receptacle and further includes a second receptacle and a cart having a first support for supporting the first receptacle at a first height and a second support for supporting the second receptacle at a second height higher than the first height, the first and second supports being position so that the first and second receptacles overlap one another so that the receptacles may be positioned proximate a prep table and waste discarded from the prep table into either the first or second receptacle.

18. The receptacle of claim 17 wherein the first and second supports are positioned at heights that allow the receptacles to be positioned under a conventional kitchen prep table for use and storage therewith.

19. An organic waste bin storage cart comprising:
a frame having staggered storage compartments with an upper storage compartment positioned toward a first side of the frame and a lower storage compartment positioned toward a second side of the frame opposite the first side;
at least three wheels connected to the bottom of the frame; and
handles connected to the frame for directing the cart during transport.

20. The organic waste bin storage cart of claim 19 wherein the frame is metal and the handles are formed integral to the second side of the frame and are substantially D-shaped to provide ergonomic grips for transporting the organic waste bin storage cart.
